(19) United States
(12) Patent Application Publication
(10) Pub. No.: US 2011/0255820 A1
(43) Pub. Date: Oct. 20, 2011

(54) ROLLER BEARING

(75) Inventors: Martin Janek Caspall, Norfolk (GB); Stuart Crispin Morris, Norfolk (GB); Brian Edward Earthrowl, Norfolk (GB)

(73) Assignee: Cooper Roller Bearings Company Limited, Norfolk (GB)

(21) Appl. No.: 13/170,988

(22) Filed: Jun. 28, 2011

Related U.S. Application Data
(63) Continuation-in-part of application No. 12/108,355, filed on Apr. 23, 2008, now abandoned.

(51) Int. Cl. F16C 19/34; F16C 19/38; F16C 43/04

(52) U.S. Cl. 384/571

(57) ABSTRACT

A split roller bearing comprising an inner ring including an inner race, an outer ring including an outer race, a cage mounted between the inner and outer races, said cage mounting t rollers which engage the inner and outer races, said inner ring and inner race, outer ring and outer race, and cage each comprising two substantially semicircular parts, the relevant semicircular parts being mounted end-to-end to provide a circular component, whereby the two semicircular parts of the inner ring and inner tapered race, outer ring and outer race, and cage, may be separated from one another to allow the roller bearing to be dismantled when worn without removal of the component supported by the bearing.

This application is a Continuation In Part of U.S. patent application Ser. No. 12/108,355 filed Apr. 23, 2008, which claims the benefit of Great Britain Patent Application No. 0707940.3 filed Apr. 25, 200, both assigned to the assignee of the present application, and incorporated herein by reference.

### BACKGROUND

Cylindrical roller bearings generally comprise an inner ring which includes an outwardly facing raceway or bearing surface, an outer ring which includes an inner facing raceway, and mounted between them, a row of rollers which engage the two raceways, the rollers being mounted in a cage.

In a cylindrical roller bearing thrust loads are carried between the ends of the rollers and adjacent faces of roller guide lips. This is a sliding contact which is difficult to lubricate and thus the thrust load carrying capacity is relatively low compared to other bearing types, particularly at high shaft speeds.

One bearing type that is able to support high thrust loads is the taper roller bearing. In this arrangement, the raceways and rollers have conical surfaces. For a single raceway, the apices of the cones of the raceways and rollers are common and coincide with the bearing centre line.

Taper roller bearings are used extensively, particularly in gearboxes and axle boxes. However, one of the disadvantages of taper roller bearings is that it is not easy to replace relevant parts of the bearing when worn. To do so, it is necessary to substantially dismantle the gear box or axle box because one part of the taper roller bearing, for example the inner ring is mounted to a shaft, and the outer ring to a housing. This can be overcome by splitting the components of the taper roller bearing in a plane through the axis (see U.S. Pat. No. 2,253,412), but this introduces problems and is difficult and expensive to achieve and is not commonly done.

Thus, transversely cutting the surfaces of a raceway introduces the possibility that the rollers will not roll smoothly over the cut joints which enable the raceway to be separated into two halves which may be removed from the bearing. Cutting the raceway at an angle to the axis of the bearing allows a smoother rotation of a roller over the joint. Whilst transversely cutting a raceway in this way is disclosed for non-taper roller bearings, (see for example the U.S. Pat. No. 5,630,669 above) this has not generally been used for the inner raceways of taper roller bearings because of its greater width allowing the mounting of clamping rings on each side of the raceway, To further improve the smooth passage of the roller over the joints we would prefer to provide the angle of the end surfaces of the semicircular parts of the inner tapered race to be at as acute angle as possible but his is particularly difficult with the inner ring and inner race because the width of the component makes the arcuate distance between the opposite ends of an end surface to be such as to make it difficult to separate the two semicircular parts.

The exemplary embodiment provides one or more features to reduce this problem.

### BRIEF SUMMARY

According to a first aspect, the exemplary embodiment provides a taper roller bearing comprising an inner ring including an inner tapered race, an outer ring including an outer tapered race, a cage mounted between the inner and outer tapered races, said cage mounting tapered rollers which engage the inner and outer races, said inner ring and inner tapered race, outer ring and outer tapered race, and cage each comprising two substantially semicircular parts, the relevant semicircular parts being mounted together to provide a circular component, the two semicircular parts of the inner ring and inner tapered race each including end surfaces which engage with the end surfaces respectively of the other semicircular part, rollers rolling across the inner tapered race of each semicircular parts from a leading to a trailing end surfaces and each semicircular part of the inner tapered race adjacent at least its leading edge includes a relief portion whereby in use a roller passes over the relief portion of the semicircular part of an inner race before engaging the inner race.

In this case the provision of the relief portions allows the tapered rollers to pass smoothly over the joints between the semicircular parts of the inner ring and inner tapered race.

To improve the smooth passage of the roller over the joints, one embodiment provides the angle of the end surfaces of the semicircular parts of the inner tapered race to be at as large an angle as possible with respect to the bearing axis but this is particularly difficult with the inner ring and inner race because the width of the component makes the arcuate distance between the opposite ends of an end surface to be too large and hence makes it difficult to remove the two semicircular parts to service the bearing.

According to a second aspect, the exemplary embodiment provides a roller bearing comprising an inner ring including an inner race, an outer ring including an outer race, a cage mounted between the inner and outer races, said cage mounting rollers which engage the inner and outer races, said inner ring and inner race, outer ring and outer race, and cage each comprising two substantially semicircular parts, the relevant semicircular parts being mounted end-to-end to provide a circular component the two semicircular parts of the inner ring each including end surfaces, the end surfaces of one semicircular part being mounted together with the end surfaces of the other semicircular part, a first part of each end surface being disposed at a first angle to the axis of the bearing, a second part of each end surface being disposed at a second generally opposed angle to the axis of the bearing, and a third part of each end surface being disposed at a third angle to the axis of the bearing.

In this way the arcuate distance between the opposite ends of an end surface is reduced.

Furthermore, where opposite sides of the inner ring are formed with a lateral surface to mount a respective clamping ring, the end surfaces of said lateral surfaces may provide said third part and a fourth part of the end surface, said third and fourth parts being a smaller angle to the axis than the first and second parts.

In a preferred arrangement, wherein said inner and outer races and rollers are tapered, said inner ring mounts a second inner tapered race, said outer ring mounts a second outer tapered race, a cage (which may be the same cage) mounted between the second inner and outer tapered races, said cage mounting a second set of tapered rollers which engage the second inner and outer races, said inner ring and inner tapered race, outer ring and outer tapered race, and cage each comprising two substantially semicircular parts, the relevant semicircular parts being mounted end-to-end to provide a circular component, the taper of the second inner and outer races and the second set of rollers being oppositely disposed to the taper of the first inner and outer races and first set of rollers.

Thus the split taper bearing is preferably a double row bearing with the rows set in a back-to-back format (i.e. with inwardly convergent contact angles) to give a bi-directional thrust load carrying capability.

Preferably the inner and/or outer ring is split using an angled cut to provide the two semicircular portions. In this way, the passage of the rollers over the joint is smoothed as the joint is set at an angle to the axis of the bearing. The magnitude of this angle is a compromise between ease of assembly and smooth running. For smooth running the angle should be as large as possible, but because of the overhang from the diameter, this causes problems in fitting, particularly the inner race over the shaft. In the taper bearing, the joint angle has to be adjusted to allow for race surfaces are that are conical rather than cylindrical.

The range of angles of the split relative to the axis of the bearing may typically be between 6° and 30°, or 6° and 20°. Where the inner ring is to mount a shaft, preferably the inner ring is clamped to the shaft by clamping rings.

Preferably each semicircular part of the inner race adjacent at least its leading end surface includes a relief portion whereby in use a roller passes over the relief portion before engaging the inner race

According to a further aspect, the exemplary embodiment comprises a method of manufacturing a taper roller bearing comprising: (a) forming the inner ring as a unitary component, (b) cutting said inner ring into two substantially semicircular parts by means of a wire, (c) moving said wire through the ring along a path, one part of said path being at a first angle to said axis to provide said first part of an end surface of the semicircular parts formed by the method, a second part of said path being at a second angle to said axis to provide said second part of an end surface of the semicircular parts formed by the method, and a third part of said path being at a third angle to said axis to provide said third part of an end surface of the semicircular parts formed by the method, (d) carrying out the step (c) at a substantially diametrically opposite position to provide a second end surface of said semicircular parts.

### BRIEF DESCRIPTION OF THE DRAWINGS

We will now describe split taper roller bearings comprising preferred embodiments of the invention with reference to the accompanying drawings in which:

FIG. 1 is an axial section through a split taper roller bearing in accordance with a first embodiment of the invention,

FIG. 2 is a perspective view of a cage for use in the bearing of FIG. 1,

FIG. 3 is a perspective view of part of a so-called cartridge which mounts the outer ring,

FIG. 4 is an axial section through the cartridge of FIG. 3,

FIG. 5 is a part transverse section though the inner ring and associated raceway including a leading edge of one end of the inner ring showing a relief portion provided at the leading edge,

FIG. 6 is a part transverse section similar to FIG. 5 of an alternative arrangement,

FIG. 7 is a part transverse section similar to FIGS. 5 and 6 but of an outer ring and outer raceway with a relief portion,

FIG. 8 is an axial section through an outer ring and outer raceway,

FIGS. 9 and 10 are outside views of the inner ring and inner raceways of two further embodiments of the invention,

FIGS. 11 and 12 show a roller passing over a joint between semicircular inner race portions,

FIGS. 13-15 illustrate the distribution of load over the length of the rollers in various configurations, and

FIG. 16 is a view similar to FIG. 10 of a four row bearing.

### DETAILED DESCRIPTION

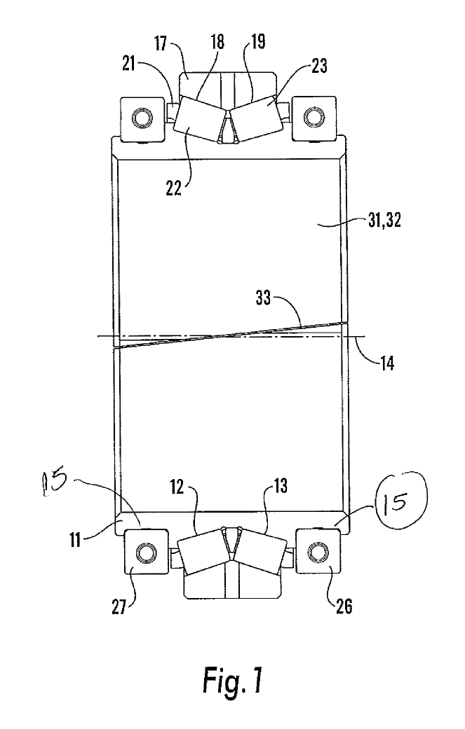

Referring to FIG. 1, there is shown a taper roller bearing in accordance with the invention. An inner ring 11 includes two races or raceways 12, 13 which each include bearing surfaces 35. The two raceways 12, 13, are set in a back-to-back format that is they are set at opposite angles to the axis 14 of the bearing i.e. they have opposite tapers.

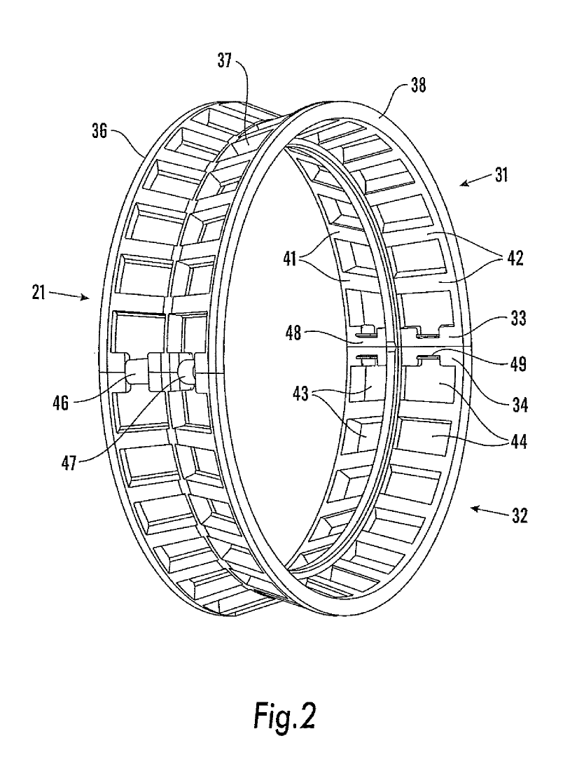

There is furthermore provided an outer ring 17 with two races or raceways 18, 19 at similar (but not identical as will be clear later) opposite angles to the axis 14 to the raceways 12, 13. Mounted between the inner 11 and outer 17 rings is a circular cage 21 (illustrated in more detail in FIG. 2), the cage mounting two side by side rows of rollers 22, 23, rollers 22 being mounted between raceways 12 and 18, and rollers 23 being mounted between raceways 13 and 19. The rollers are slightly conical. The apices of the cones of the raceways 12 and 18 and rollers 23 are common and lie on the bearing centre line, and the apices of the cones of the raceways 12 and 18 and rollers 23 are common and lie on the bearing centre line, the two apices lying on the axis on opposite sides of the bearing.

Lateral surfaces 15 of the inner ring 11 mount two clamping rings 26, 27 for clamping the inner ring to a shaft and which in some configurations also retain the cage 21 axially.

The inner ring 11 is in the form of two semicircular ring portions 31, 32 there being provided a cut or split 33, 34 on diametrically opposite sides of the inner ring 11 and as is clear from FIGS. 1 and 3, the line of the cut or split 33 is at an angle to the axis 14. In a similar way, the outer ring 17 is provided by two semicircular ring portions with diametrically opposed splits similar to the splits 33, 34. The angle of the angled cut 33, 34 to the axis of the bearing is preferably between 6° and 30°, or 6° and 20°. The cuts or split 33, 34 form end surfaces 33, 34 to the semicircular ring portions 31, 32. Whilst the inner ring and outer ring will normally be made as a unitary item and then cut into two semicircular parts, it is possible to manufacture the semicircular items separately.

We now describe the cage 21 in more detail, with reference to FIG. 2. The cage can be made of a variety of materials, for example machined from solid metal, investment cast in metal, vacuum moulded or injection moulded from engineering plastics material. The cage to be described is moulded of engineering plastics material.

The cage 21 comprises a pair of substantially semicircular moulded plastic halves 31, 32, joined together at their ends 33, 34, the moulded halves 31, 32 each having three parallel continuous side wall portions 36, 37, 38 which (as seen in FIG. 1) overlap the ends of the rollers. Two (36. 37) of the sides form the sides of the moulded plastic halves 31, 32, and bars 41, 42 spaced apart along the continuous wall portions 36, 37, 38 join the continuous side wall portions 36, 37, 38 together. The adjacent bars 41, 42, and continuous wall portions 36, 37, 38 form two side by side series of pockets 43, 44 in which the two rows 22, 23 of rollers and retained.

The opposite ends 33, 34 of each semicircular cage half 31, 32, are formed with releasable fixing means 46, 47 such as steel spring clips engaging around end bar 48, 49.

Thus by providing the inner 11 and outer 17 rings and cage 21 in the form of two semicircular halves, the bearing assembly may be dismantled without removing the shaft which the bearing supports.

In use, the disassembled parts are fitted together as follows.

Assuming the bearing is to mount a shaft (not shown), the two semicircular inner ring portions 31, 32 are placed around the shaft, mounted and to end together with the two semicircular portions of the clamping rings 26, 27. The clamping rings may be bolted together by bolts 51, 52, 53, 54 shown in FIG. 1. When the inner ring portions are initially fitted to a shaft of the correct size, there will be a gap at both splits of approximately 0.5 mm. Clamping force between the inner ring 11 and the shaft depends on the induced load in the clamping ring bolts 51-54 when tightened to the specified torque. This system can generate a level of interference between inner ring 11 and shaft that is comparable to a shrink fit of a solid bearing.

The assembly continues with the two semicircular cage portions (with roller rows 22, 23 inserted in the relevant rows of pockets 43, 44) being mounted end to end around the inner ring and joined together by means of the spring clips 46, 47. The two semicircular outer ring portions are then mounted around the cage. The two halves of a cartridge 62 surround the two semicircular outer ring portions and are then bolted together to from the complete assembly.

Disassembly is the reverse of assembly and as is clear the parts of the bearing, for example worn raceways and worn rollers may be replaced whilst leaving the shaft in situ. This is a considerable technical benefit not available hitherto in respect of taper bearings.

As set out above, a taper roller bearing is provided not only to provide a suitable radial load supporting bearing for the rotating shaft but also to absorb axial loads of the shaft with respect to the bearing. If the axial loads are in a single known direction, then a single row of rollers may be provided but we have described a bearing with respect to the Figures which includes two oppositely pitched rows of rollers which can therefore absorb axial loads in opposite directions.

Because the forces on a taper roller tend to move it along its axis, across the raceway, away from the apex of the cone, a retaining lip is required on one raceway to maintain the rollers in position. In the design shown the lip is on the inner race, but can be placed on the outer race to facilitate the manufacture of the races if required. As will be noted, the rollers have profiled (i.e. domed) end faces to facilitate the lubrication of the sliding contact.

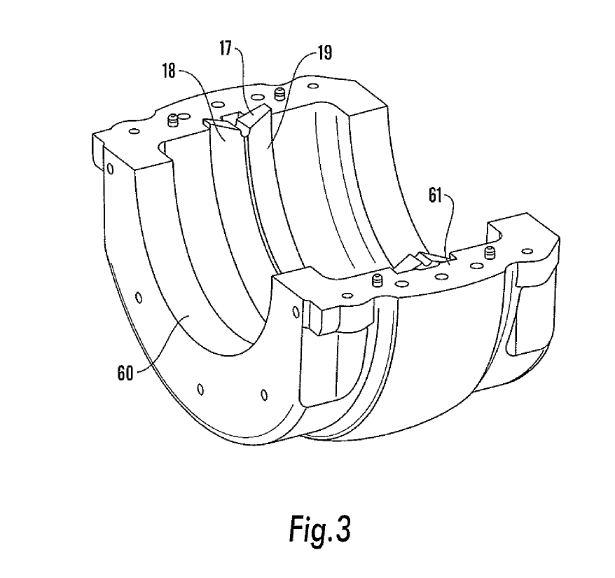

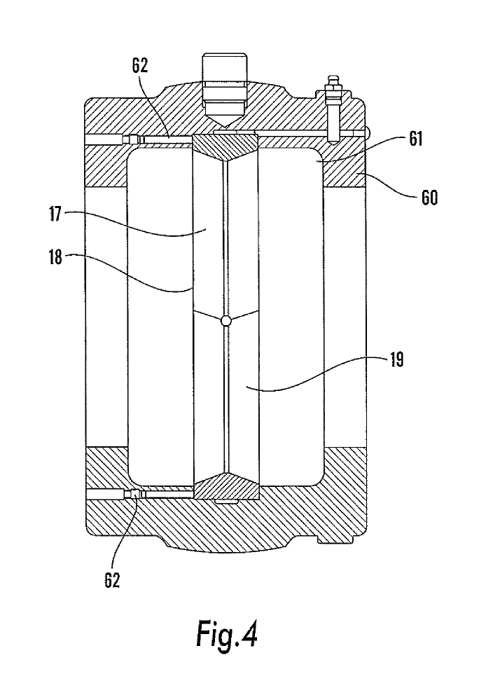

The outer ring 17 also contains both outer raceways 18, 19 and is split in a V-shape (FIG. 3) that provides a degree of location between the outer race halves. In a radially loaded cylindrical roller bearing, the load is supported by the rollers contained within an arc that extends roughly 30 degrees either side of the direction of action of the load. (The true extent of the arc depends on the magnitude of the load and the diametric clearance of the bearing). Normally the load is close enough to the vertical to avoid coincidence of loaded rollers and outer race joints. The addition of an axial load does not change this situation. In a taper bearing, if the load is predominantly in an axial direction it is shared among all the rollers and coincidence of loaded roller and outer race joint is unavoidable. As shown in FIG. 3, the outer ring is fitted into a cartridge 60 whose interior surface has been machined with a groove, called the outer race seat 61. There is a close tolerance fit between the outer ring 17 and the seat 61 that keeps the joint gap to a minimum. Screws 62 set in an axial direction around the circumference of the outer ring seat 61 (side screws) ensure that both halves of the outer ring 17 are pushed to one side of the seat 61 that acts as a register and the halves in circumferential alignment (FIG. 4).

Cartridge joints are reinforced with extra bolts to withstand the bursting force caused by the wedge action of the rollers.

In use, as the ratio of axial to radial loads increase, the resultant load is biased towards one row of rollers. The cage 21 (FIG. 2) retains both rows 22, 23 of rollers so that the unloaded row of rollers are driven by the loaded row of rollers, minimising the risk of race damage due to roller skid.

The back-to-back arrangement allows the bearing to accommodate large tilting moments and ensure that the cartridge 60 aligns correctly in an outer housing. By using a lubricated and spherical connection between the cartridge 60 and the outer housing, very low frequency misalignments of the shaft axis can be accommodated by the movement between the spherical surfaces whilst maintaining the concentricity of seal and shaft which is not possible with spherical roller bearings.

When solid taper bearings are used in pairs, diametric clearance can be adjusted by means of spacer rings between either the inner or outer races. Negative clearance or preload is sometimes used to increase the stiffness of the bearing arrangements. In the new present arrangement, because the rings 11, 17 contain both tracks in a single part, spacers are not required. Bearing clearance is set to be in the standard clearance range and is determined by the dimensions and tolerances of the raceways and also by the size of the shaft on which the bearing is mounted.

We now refer to FIGS. 5 to 7 which show alternative arrangements.

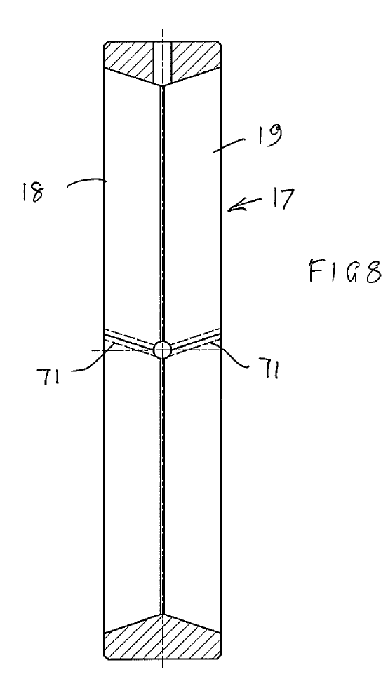

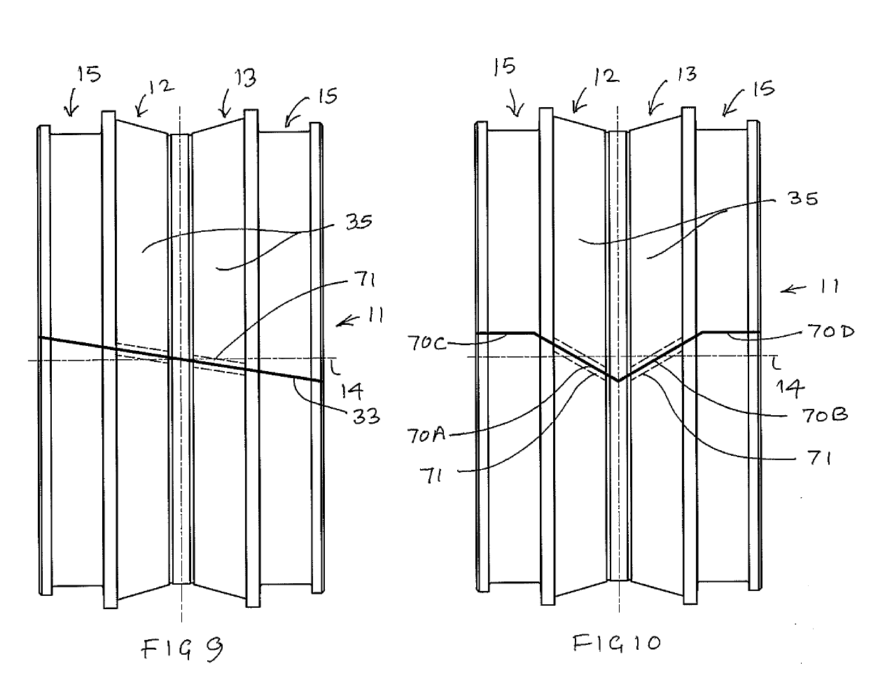

FIG. 5 is a part transverse part section though a semicircular portion of an inner ring and associated inner race, showing a leading edge 33L thereof. As is clear, the leading edge 33L of the inner race semicircular portion includes a relief portion 71. The depth and extent of the relief portion 71 is exaggerated for clarity. The leading edge 33L is the edge over which a roller passes from the other inner race semicircular portion onto the respective semicircular inner race portion The opposite edge will normally be the trailing edge. Of course, if the bearing is intended for use where the shaft rotates in both directions, both edges will sometimes be leading edges and sometimes trailing edges. The relief portion extends form one axial side to the other of its inner race semicircular portion as illustrated in FIGS. 9 and 10.

The relief portion 71 has a surface 73 which is substantially cylindrical. The substantially cylindrical surface 73 of said relief portion is cylindrical about an axis 74 parallel to the leading edge 33L. Where the surface 73 of the relief portion 71 merges with the surface 35 of the inner tapered race, the tangents of the two surfaces 73. 75 are coplanar.

The depth of the relief portion 71 is 1 to 100 micron, preferably 10 to 50 microns.

FIG. 7 shows a similar arrangement where the relief is provided at the leading edge of the outer race. The different configurations of FIGS. 5 and 6 may be applied to the outer race.

We now refer to FIG. 6. It is very difficult to accurately manufacture the bearing so that the surface 73 of the relief portion 71 merges with the surface 35 of the inner tapered race so that the tangents of the two surfaces are coplanar.

In the alternative shown in FIG. 6, where the surface of the relief portion 73 merges with the surface 35 of the inner tapered race, the tangents of the two surfaces are at a small positive angle to one another to provide a shallow corner at 75. This is much easier to achieve. It is done by slightly moving the position of the axis 74.

Although a corner 75 is not desirable, it will be appreciated that this is a very shallow corner and much less of a stress raiser than the abrupt corner that occurs without a relief. The same depth of relief can be achieved by adjusting the radius of the relief.

It will be understood that whilst we have shown a relief portion 71 at the leading edge 33L, a similar relief 72 may be provided at the trailing edge 33T of the semicircular portion of the race (that is, where the roller passes to the other inner race).

Referring to FIGS. 9 and 10, FIG. 9 shows an inner ring 11 with a tapered inner race similar to that of FIG. 1 with a straight cut 33.

FIG. 10 shows an inner ring 11 with an alternative arrangement of cut 70. Both FIGS. 9 and 10 show relief portions 71.72 in the race surface 35 extending along the edges 33 of the cut ends between the two semicircular parts of the inner ring 11.

In the arrangement of FIG. 9, it will be observed that a roller passing over the joint between inner race semicircular portions will be at some point substantially or completely over the relieved portion 71, 72 of the track. This can lead to the roller becoming misaligned which causes problems as it enters the ‘normal’ portion of the race surface 35. The relieved portion 71, 72 could be made narrower, achieving a similar depth of relief using a smaller radius of curvature for the relief, but this causes a greater stress concentration on the roller. Alternatively, the angle of the cut forming the edges 33 relative to the axis 14 could be increased. However, this causes a problem in assembling the bearing, as each half of the bearing does in fact wrap around more than one half of the circumference of the journal As the angle of the split is increased the wrap-around increases and it becomes more difficult to install the race on the shaft. (i.e. the arcuate distance between the opposite ends of an end surface is too great). It is possible to avoid this problem by removing material from the bore of the race, but this leads to an undesirably large unsupported area of the race if carried to excess.

FIG. 10 provides a solution to or at least alleviates this problem. The two semicircular parts of the inner ring each include end surfaces 70, the end surface of one semicircular part being mounted together with the similar end surface of the other semicircular part. One part 70A of each end surface 70 is disposed at a first angle to the axis 14 of the bearing, a second part 70B of each end surface is disposed at a second generally opposed angle to the axis of the bearing, a third part 70C of each end surface being disposed at a third angle to the axis of the bearing, and a fourth part 70D of each end surface is disposed at a fourth angle to the axis of the bearing. In the example, the first and second angles are the same but opposite thereby providing a “V” shape of joint, and the third and fourth angles are zero being parallel to the axis. It will be noted that the first and second parts 70A and 70B extend from the centre of the inner ring 11 to the outer edge of surface 35 of the respective races 12, 13 so that there is no discontinuity across the relevant race surface. The third and fourth parts 70C and 70D extend across the two lateral surfaces 15 (which mount clamping rings).

By using a ‘V’ joint it is possible to increase the angle of the split at the races whilst maintaining an acceptable wrap-around of the race halves (i.e. the arcuate distance between the opposite ends of an end surface is reduced). If the V joint is extended to the end faces of the race is approximately halved for a given angle of split. This can be further reduced by the ‘horizontal’ (axial) third and fourth parts of the split shown. (An angled split is only required on the roller track, not under the clamping rings). This means that for a given wrap-around, the first and second angle can be increased still further.

It will be seen that now a roller passing over the split is still supported over a substantial proportion of its length at a given instant.

The complexity of the cut four parts 70A-D at different angles is difficult to achieve by conventional techniques. We have realised that it may be produced by

(a) forming the inner ring as a unitary component,

(b) cutting said inner ring into two substantially semicircular parts by means of a wire,

(c) moving said wire through the ring along a path, one part of said path being at a first angle to said axis to provide said first part of an end surface of the semicircular parts formed by the method, a second part of said path being at a second angle to said axis to provide said second part of an end surface of the semicircular parts formed by the method, and a third part of said path being at a third angle to said axis to provide said third part of an end surface of the semicircular parts formed by the method,

(d) carrying out the step (c) at a substantially radially opposite position to provide a second end surface of said semicircular parts.

Steps (c) and (d) could be carried out separately at the substantially radially opposite positions. We prefer to carry out steps (c) and (d) simultaneously, that is by using a single wire of suitable length, moving said wire through the ring simultaneously at the substantially radially opposite positions. With this latter method, the ends of one the semicircular parts would be of identical shape and the ends of the other semicircular part would be identical to each other but a mirror image of the ends of the one semicircular part.

The cutting of the initial inner ring by means of a wire may use a wire saw, but preferably uses an electric discharge machining process.

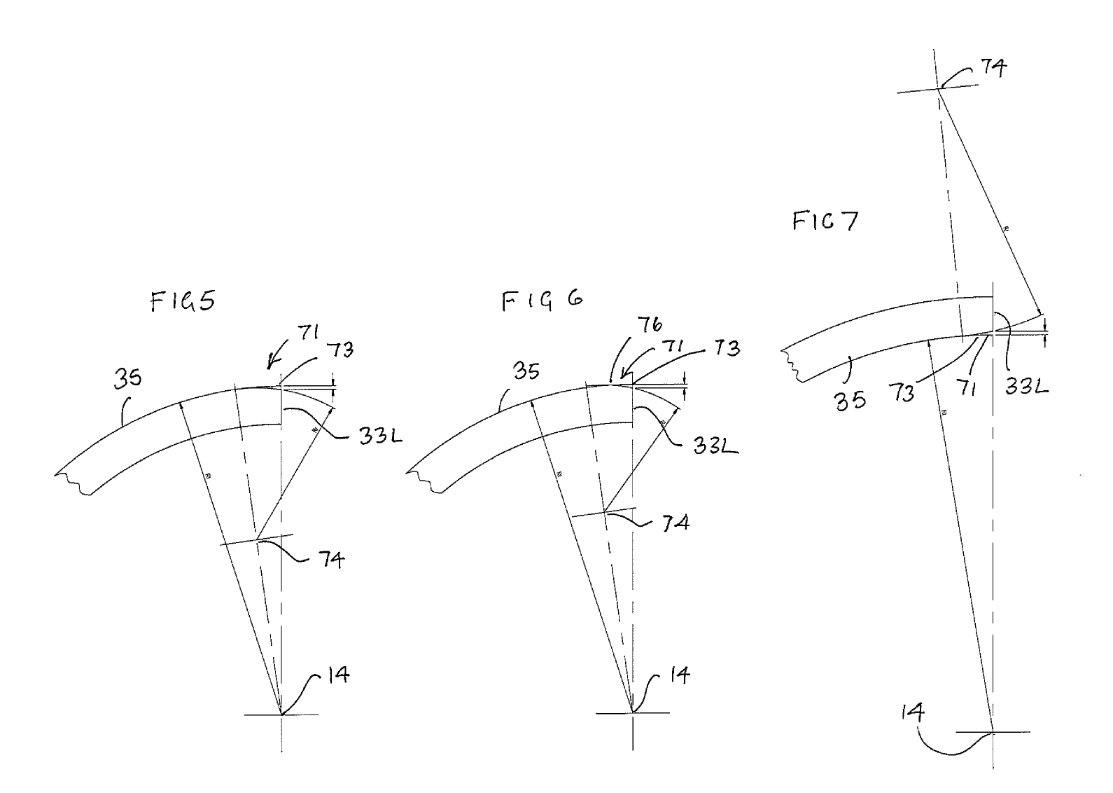

FIG. 8 illustrates an outer race with relief portions and first and second angled parts 70A and 70B.

FIG. 16 shows a view similar to FIG. 10 of a four row bearing. (essentially 2× two row bearings formed into one bearing). Such bearings are used in some heavy duty applications including the steel industry. Because of their width, is is difficult to provide unitary inner and outer rings with angled cuts. However, this problem is solved by the principles shown in FIG. 10.

If the bearing was to be formed laterally by two two-row bearings mounted side by side, then each bearing would individually conform to the principles laid out in FIG. 10. However, all four inner races may be formed on one unitary inner ring, and/or all four outer races formed on one unitary outer ring. In this case, there may be provided a change in direction of the cut or split between each race with the possibility of an axial portion 15 under each clamping ring seat (of which there might be three (one at each end, and one in the middle with two rows of rollers each side

We now refer to FIGS. 11-15. FIGS. 11 and 12 show a roller 22, 23 passing over the cut 33. In the upper one it is a plain cut, and in the lower one it is a relieved cut.

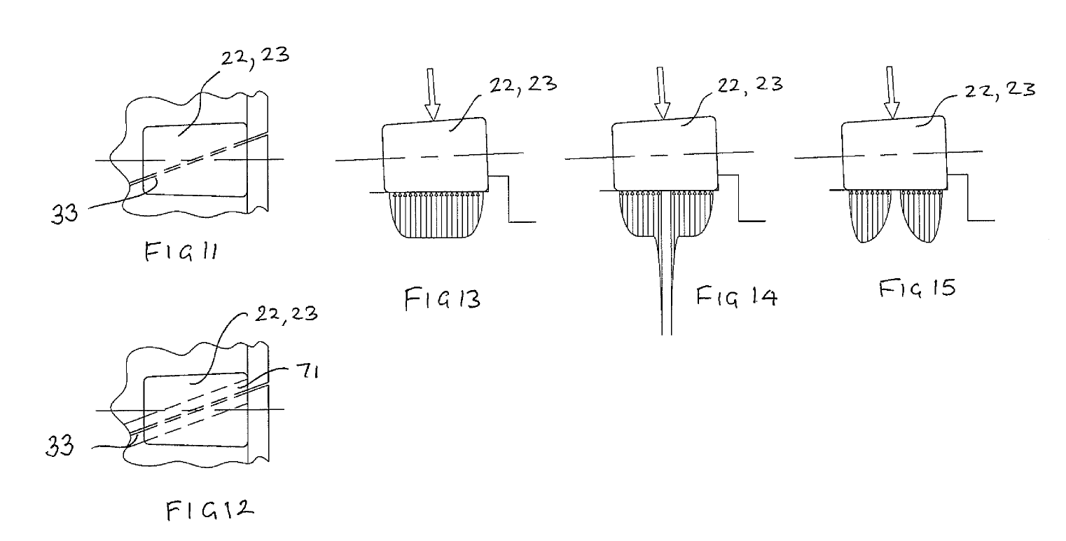

The other three views in FIGS. 13-15 show a section through the track and roller and the contact load distributions obtained.

In FIG. 13, the roller is not over the cut. A more-or-less uniform (or at least a smooth) load distribution is achieved. It might be expected from this view that there would be stress concentrations at the ends of the roller. However, there are relief profiles applied to the roller and/or track which reduce the contact pressures at the ends of the rollers.

In FIG. 14 the roller is passing over a plain (unrelieved) cut. There are significant stress concentrations at the abrupt corners of the cut.

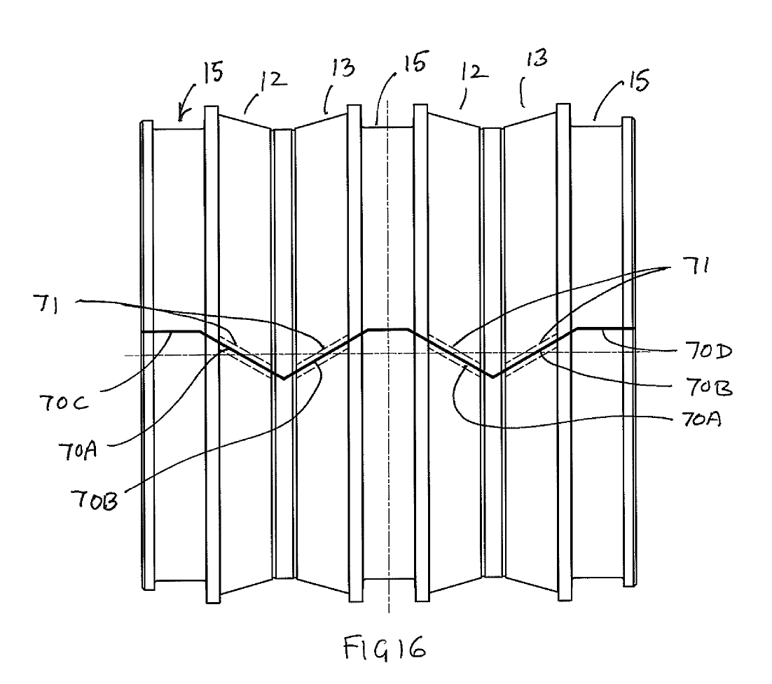

In FIG. 15, the roller is passing over a relieved cut. The stress concentrations are reduced by the smooth dropping-off of the surface of the track. The depth of relief is only a few microns or tens of microns, so that at the maximum roller load expected the loaded region just approaches the split line. It will be appreciated that under low load there will be a wider area either side of the cut line where the surfaces of the roller and track are not in contact.

It appears from the load distributions that the roller that is over the relieved cut is carrying somewhat less load than the rollers in the other situations shown, which is true. This suggests that the maximum contact pressure must therefore be increased from that shown, in order that the same total load is carried. This is in fact not true. It must be remembered that there are several or many rollers carrying the load, with just one or two rollers per row being over a cut. The remainder of the rollers (i.e. those not over a cut) carry the greater proportion of the load, and tend to control the ‘approach’ of one race to another. If the roller over the relieved cut were to carry its full share of load it would require the two races to move more closely together, but they are prevented from doing so by the large number of rollers that are not over cuts. In other words, whilst the roller is over the relieved cut, that proportion of the load which it would usually carry but which it is now not carrying is predominantly distributed to the large number of rollers that are not over cuts, rather than being concentrated over a smaller area of the same roller.

Various arrangements of taper roller bearings have been shown, but in many instances, the principles may be applied to non-taper roller bearings. The invention is not restricted to the details of the foregoing examples.

We claim:

1. A taper roller bearing comprising
an inner ring including an inner tapered race,
an outer ring including an outer tapered race,
a cage mounted between the inner and outer tapered races,
said cage mounting tapered rollers which engage the inner and outer races,
said inner ring and inner tapered race, outer ring and outer tapered race, and cage each comprising two substantially semicircular parts, the relevant semicircular parts being mounted together to provide a circular component, the two semicircular parts of the inner ring and inner tapered race each including leading and trailing end surfaces which engage with the trailing and leading end surfaces respectively of the other semicircular part, rollers rolling across the semicircular parts of the inner tapered races from their leading to their trailing end surfaces and each semicircular part of the inner tapered race adjacent at least its leading end surface includes a relief portion whereby in use a roller passes over the relief portion before engaging the inner race.

2. A taper roller bearing as claimed in claim 1 in which the surface of said relief portion is substantially cylindrical.

3. A taper roller bearing as claimed in claim 2 in which said substantially cylindrical surface of said relief portion is cylindrical about an axis parallel to the leading edge of the adjacent end surface.

4. A taper roller bearing as claimed in claim 3 in which where the surface of the relief portion merges with the surface of the inner tapered race, the tangents of the two surfaces are coplanar

5. A taper roller bearing as claimed in claim 3 in which where the surface of the relief portion merges with the surface of the inner tapered race, the tangents of the two surfaces are at a small positive angle to one another to provide a shallow corner

6. A taper roller bearing as claimed in claim 1 in which the depth of the relief is 1 to 100 micron.

7. A taper roller bearing as claimed in claim 1 in which the depth of the relief is 10 to 50 micron.

8. A taper roller bearing as claimed in claim 1 in which, said inner ring mounts a second inner tapered race,
said outer ring mounts a second outer tapered race,
said cage mounting a second set of tapered rollers which engage the second inner and outer races,
said inner ring and inner tapered race, outer ring and outer tapered race, and cage each comprising two substantially semicircular parts, the relevant semicircular parts being mounted together to provide a circular component,
the taper of the second inner and outer races and the second set of rollers being oppositely disposed to the taper of the first inner and outer races and first set of rollers.

9. A taper roller bearing as claimed in claim 8 comprising a double row bearing with the rows set in a back-to-back format with inwardly convergent contact angles, whereby to provide a bi-directional thrust load carrying capability.

10. A taper roller bearing as claimed in claim 1 in which the inner ring is cut at an angle to the axis to provide the two semicircular portions.

11. A taper roller bearing as claimed in claim 1 in which the outer ring is cut at an angle to the axis to provide the two semicircular portions.

12. A taper roller bearing as claimed in claim 1 in which the angle of the angled cut to the axis of the bearing is between 6° and 30°, or 6° and 20°.

13. A taper roller bearing as claimed in claim 1 in which the inner ring mounts a shaft and the inner ring is clamped to the shaft by clamping rings.

14. A taper roller bearing as claimed in claim 1 in which each inner tapered race adjacent at least its trailing edge includes a further relief portion disposed whereby in use a roller passes over the further relief portion before engaging the other inner race.

15. A roller bearing comprising
an inner ring including an inner race,
an outer ring including an outer race,
a cage mounted between the inner and outer races,
said cage mounting rollers which engage the inner and outer races,
said inner ring and inner race, outer ring and outer race, and cage each comprising two substantially semicircular parts, the relevant semicircular parts being mounted together to provide a circular component, the two semicircular parts of the inner ring each including end surfaces, the end surfaces of one semicircular part being mounted together with the end surfaces of the other semicircular part, a first part of each end surface being disposed at a first angle to the axis of the bearing, a second part of each end surface being disposed at a second generally opposed angle to the axis of the bearing, and a third part of each end surface being disposed at a third angle to the axis of the bearing.

16. A roller bearing as claimed in claim 15 wherein opposite sides of the inner ring are each formed with a lateral surface mounting a clamping ring, the end surfaces of said lateral surface providing said third part and a fourth part of the end surface, said third and fourth parts being at a smaller angle to the axis than the first and second parts.

17. A roller bearing as claimed in claim 16 in which said third and fourth parts are parallel to the axis of the bearing.

18. A roller bearing as claimed in claim 15 in which, said inner ring mounts two inner tapered races,
said outer ring mounts two outer tapered races,
said cage mounts two sets of tapered rollers which engage the two inner and outer tapered races,
said inner ring and inner tapered races, outer ring and outer tapered races, and cage each comprising two substantially semicircular parts, the relevant semicircular parts being mounted together to provide a circular component,
the taper of the second inner and outer races and the second set of rollers being oppositely disposed to the taper of the first inner and outer races and first set of rollers.

19. A roller bearing as claimed in claim 15 in which said first angle is between 6° and 30°, or 6° and 20°.

20. A roller bearing as claimed in claim 19 in which said second angle generally opposed to said first angle is between 6° and 30°, or 6° and 20°.

21. A roller bearing as claimed in claim 15 wherein, in use, rollers roll across the semicircular parts of the inner races from their leading to their trailing end surfaces and each semicircular part of the inner race adjacent at least its leading end surface includes a relief portion whereby in use a roller passes over the relief portion before engaging the inner race.

22. A method of manufacturing a roller bearing, comprising
(a) forming a inner ring as a unitary component,
(b) cutting said inner ring into two substantially semicircular parts by means of a wire,
(c) moving said wire through the ring along a path, one part of said path being at a first angle to said axis to provide said first part of an end surface of the semicircular parts formed by the method, a second part of said path being at a second angle to said axis to provide said second part of an end surface of the semicircular parts formed by the method, and a third part of said path being at a third angle to said axis to provide said third part of an end surface of the semicircular parts formed by the method,
(d) carrying out the step (c) at a substantially diametrically opposite position to provide a second end surface of said semicircular parts.

23. A method as claimed in claim 22 in which steps (c) and (d) are carried out at the same time using a single wire.

24. A method as claimed in claim 22 in which the wire cuts said inner ring by means of an electric discharge machining process.

25. A method as claimed in claim 21 in which the wire cuts said inner ring by means of an electric discharge machining process.
